(19) United States
(12) Patent Application Publication
(10) Pub. No.: US 2026/0048288 A1
(43) Pub. Date: Feb. 19, 2026

(54) SYSTEM AND METHOD FOR DETECTING USAGE OF A FIRE SUPPRESSION SYSTEM

(71) Applicant: Allstate Insurance Company, Northbrook, IL (US)

(72) Inventors: Timothy W. Gibson, Barrington, IL (US); Justin Wright, Chicago, IL (US)

(73) Assignee: Allstate Insurance Company, Northbrook, IL (US)

(21) Appl. No.: 19/301,431

(22) Filed: Aug. 15, 2025

Related U.S. Application Data
(60) Provisional application No. 63/684,115, filed on Aug. 16, 2024.

(51) Int. Cl. A62C 37/50; A62C 2/10; A62C 13/76

(52) U.S. Cl. CPC A62C 37/50; A62C 2/10; A62C 13/76

(57) ABSTRACT

A fire suppression system comprises a fire suppression member configured to extinguish a fire; a support member configured to removably couple the suppression apparatus to a surface; and a circuit configured to, after determining that the fire suppression member has been removed from the support member, communicate a fire suppression member removal indication to a remote device.

### CROSS-REFERENCE TO RELATED APPLICATIONS

This application claims the priority benefit of U.S. Provisional Application No. 63/684,115, filed Aug. 16, 2024, which is incorporated herein by reference in its entirety.

### BACKGROUND

### I. Field

This application generally relates to fire suppression systems. In particular, this application relates to a system and method for detecting the usage of a fire suppression system.

### II. Description of Related Art

A fire suppression device in a household, such as a fire extinguisher or fire blanket, is an essential safety tool designed to quickly control small fires before they escalate. Fire extinguishers are portable devices that discharge fire-retardant chemicals to put out fires, making them ideal for tackling kitchen fires or electrical blazes. Fire blankets, on the other hand, are made from fire-resistant materials and can be used to smother flames by covering the fire source and cutting off the oxygen supply. Both devices are easy to use and provide a fast, effective response to fires, helping to protect lives and property by preventing the spread of flames. Having these tools readily accessible and knowing how to use them can make a significant difference in an emergency situation.

### SUMMARY

In a first aspect, a fire suppression system comprises a fire suppression member configured to extinguish a fire, a support member configured to removably couple the suppression apparatus to a surface, and a circuit configured to, after determining that the fire suppression member has been removed from the support member, communicate a fire suppression member removal indication to a remote device.

In a second aspect, a computing device comprises one or more processors and one or more storage devices that comprise instruction code that is executable by the one or more processors. Execution of the instructions causes the computing device to, after a fire suppression member of a fire suppression assembly has been removed from a support member of the fire suppression assembly, receive, from the fire suppression assembly, a fire suppression member removal indication, and update a user interface of the computing device to indicate that the fire suppression member has been removed from the support member.

In a third aspect, a non-transitory computer-readable medium stores instruction code that, when executed by one or more processors of a computing device, causes the computing device to receive, from the fire suppression assembly, a fire suppression member removal indication, and update a user interface of the computing device to indicate that the fire suppression member has been removed from the support member.

### BRIEF DESCRIPTION OF THE DRAWINGS

The accompanying drawings are included to provide a further understanding of the claims, are incorporated in, and constitute a part of this specification. The detailed description and illustrated examples described serve to explain the principles defined by the claims.

FIG. 1 illustrates an environment that includes various systems/devices that facilitate detecting the usage of a fire suppression system, in accordance with example embodiments.

FIG. 2A illustrates a fire suppression system that comprises a fire blanket, in accordance with example embodiments.

FIG. 2B illustrates a fire suppression system that comprises a canister of flame-retardant, in accordance with example embodiments.

FIG. 3 illustrates fire suppression system communication circuitry of a fire suppression system, in accordance with example embodiments.

FIG. 4 illustrates a remote device, in accordance with example embodiments.

FIG. 5 illustrates operations performed by the remote device and/or the fire suppression system, in accordance with example embodiments.

FIG. 6 depicts a user interface generated by the remote device to display fire suppression system information associated with one or more fire suppression systems, in accordance with example embodiments.

FIG. 7 depicts a user interface generated by the remote device to display detailed fire suppression system information associated with a particular fire suppression system, in accordance with example embodiments.

FIG. 8 depicts a user interface generated by the remote device after a fire suppression member removal indication is received from a fire suppression system, in accordance with example embodiments.

FIG. 9 illustrates a computer system that can form part of or implement any of the systems and/or devices described above, in accordance with example embodiments.

### DETAILED DESCRIPTION

Various examples of systems, devices, and/or methods are described herein. Any embodiment, implementation, and/or feature described herein as being an “example” is not necessarily to be construed as preferred or advantageous over any other embodiment, implementation, and/or feature unless stated as such. Thus, other embodiments, implementations, and/or features may be utilized, and other changes may be made without departing from the scope of the subject matter presented herein.

Accordingly, the examples described herein are not meant to be limiting. It will be readily understood that the aspects of the present disclosure, as generally described herein, and illustrated in the figures, can be arranged, substituted, combined, separated, and designed in a wide variety of different configurations.

Further, unless the context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Therefore, such enumeration should not be interpreted to require or imply that these elements, blocks, or steps adhere to a specific arrangement or are carried out in a specific order.

Further, terms such as “A coupled to B” or “A is mechanically coupled to B” do not require members A and B to be directly coupled to one another. It is understood that various intermediate members may be utilized to “couple” members A and B together.

Moreover, terms such as “substantially” or “about” that may be used herein mean that the recited characteristic, parameter, or value need not be achieved exactly. Deviations or variations, including tolerances, measurement error, measurement accuracy limitations, and other factors known to skill in the art, may occur in amounts that do not preclude the effect the characteristic was intended to provide.

### I. Introduction

As noted above, fire suppression devices are essential safety tools designed to quickly control small fires before they escalate. In some cases, the user may not know how to properly operate the fire suppression device, or the fire might be too large to control or extinguish, leading to potentially catastrophic losses. In some instances, the user may forgo immediately contacting first responders in hopes that the fire can be extinguished. This delay in contacting the first responders can, in some cases, exacerbate these losses.

Disclosed herein are examples of systems and methods for detecting the usage of a fire suppression system that can mitigate these potential losses. Some examples of fire suppression systems comprise a fire suppression member configured to extinguish a fire, a support member configured to removably couple the suppression apparatus to a surface, and a circuit configured to, after determining that the fire suppression member has been removed from the support member, communicate a fire suppression member removal indication to a remote device. Some examples of remote devices include smartphones, tablets, laptops, desktop computers, etc.

In some examples, the remote device is configured to, after receiving the fire suppression member removal indication, communicate a first responder request indication to a first responder system. In some examples, the fire suppression system communicates the first responder request indication directly to the first responder system rather than via the remote device. In some examples, the first responder request indication specifies a particular location of the fire suppression assembly, such as a particular room in a dwelling.

In some examples, after communicating the fire suppression member removal indication to the remote device, the fire suppression system receives, from the remote device, an indication that either a first responder system has been contacted or that the fire suppression member removal indication will be ignored. In these examples, when neither of these indications is received by the fire suppression system for a predetermined period (e.g., 5 minutes), the fire suppression system automatically communicates a first responder request indication to the first responder system.

In some examples, the fire suppression member comprises a blanket of flame-resistant material, and the blanket comprises one or more handles. In these examples, the support member comprises a storage pouch configured to store the blanket in a compact form such that when the blanket is in the compact form and inserted within the storage pouch, the handles protrude from an opening of the storage pouch. In some other examples, the fire suppression member comprises a canister, which stores a consumable flame-retardant material under pressure. Some examples of these fire suppression members comprise a pressure gauge to sense the pressure of the consumable flame-retardant material.

In some examples, the fire suppression assembly is one of a plurality of fire suppression assemblies, and the fire suppression member removal indication uniquely identifies the fire suppression assembly among the plurality of fire suppression assemblies.

In some examples, the remote device, after receiving the fire suppression member removal indication, updates a user interface of the remote device to indicate that the fire suppression member has been removed from the support member. In some examples, the user interface identifies the corresponding fire suppression system associated with the fire suppression member removal indication.

In some examples, the user is requested via the user interface to indicate whether a first responder should be notified. In these examples, after receiving the indication that the first responder should be notified, the remote device communicates the first responder request indication to the first responder system. In some examples, before receiving the indication that the first responder should be notified and after a predetermined period from receipt of the fire suppression member removal indication, the remote device automatically communicates the first responder request indication to the first responder system.

In some examples, the user of the remote device has an insurance policy covering the user's dwelling. In some examples, the remote device communicates information such as the number and types of fire suppression systems in the dwelling, information indicative of inspection dates and usage (if any) of the fire suppression systems, etc., to a loss prediction system of an insurance company associated with the insurance policy. In some examples, the loss prediction system is configured to assess the risk and/or amount of loss associated with the insurance policy to decrease as the number of fire suppression assemblies within the dwelling increases. In some examples, the loss prediction system is configured to assess an increase in risk/loss with increased usage of the fire suppression assemblies or after determining that the fire suppression assemblies are not being inspected within the expected timeframes.

### II. Example Environment

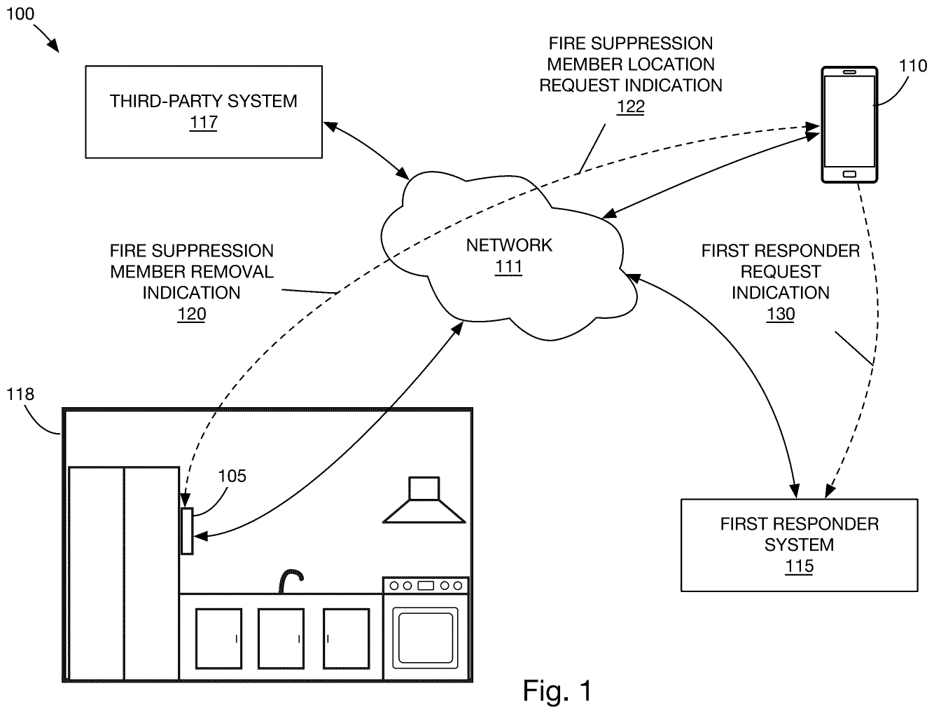

FIG. 1 illustrates an example of an environment 100 that includes various systems/devices that facilitate detecting the usage of a fire suppression system. Example systems/devices of the environment 100 include a fire suppression system 105 positioned within the kitchen 118 of a dwelling, a remote device 110, a first responder system 115, and a third-party system 117. In some examples, the fire suppression system 105, remote device 110, the first responder system 115, and the third-party system 117 communicate information to one another via a communication network 111, such as the Internet, POTS (plain old telephone service) system, a cellular communication network, a Wi-Fi network, etc. Some examples of the remote device 110 correspond to smartphones, tablets, computers, etc.

Some examples of the fire suppression system 105 are configured to communicate a fire suppression member removal indication 120 to the remote device 110 after determining that the fire suppression system 105 is being used (e.g., to suppress a fire). Some examples of the remote device 110 are configured to communicate a first responder request indication 130 to the first responder system 115 either automatically after receiving the fire suppression member removal indication 120 or responsive to user input to do so.

Some examples of the third-party system 117 correspond to a loss-prediction system configured to predict loss associated with an insurance policy. As previously indicated, the loss prediction system may be configured to assess the risk and/or amount of loss associated with the insurance policy based on factors such as the number of fire suppression assemblies within a particular dwelling, the amount of usage of the fire suppression assemblies, how regularly the fire suppression assemblies are being inspected, etc.

a. Example Fire Suppression Assemblies

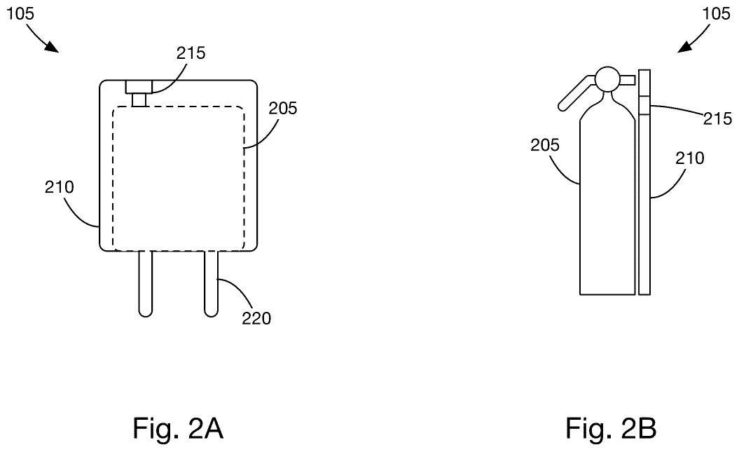

FIGS. 2A and 2B illustrate examples of fire suppression systems 105. Each fire suppression system 105 comprises a fire suppression member 205 configured to extinguish a fire, a support member 210 configured to removably couple the fire suppression member 205 to a surface, and a fire suppression system communication circuitry 215 configured to communicate a fire suppression member removal indication to a remote device 110 after determining that the fire suppression member 205 has been removed from the support member 210.

Referring to FIG. 2A, the fire suppression member 205 and the support member 210 of the fire suppression system 105 correspond respectively to a blanket 205 and a storage pouch 210. Some examples of the blanket 205 are constructed from a base layer of tightly woven fiberglass fabric that is coated with a flame-retardant chemical that enhances its fire suppression capabilities. In some examples, the edges of the blanket 205 are reinforced, for example, with a double-stitched seam made from high-strength aramid fibers to prevent fraying and ensure longevity. Some examples of the blanket 205 are configured to be folded into a compact size to facilitate insertion of the blanket within the storage pouch 210. In this regard, some examples of the blanket 205 comprise one or more straps 220 that are attached to one or more edges of the blanket 205. Some examples of the straps 220 are similarly constructed from a tightly woven fiberglass fabric that is coated with a flame-retardant chemical. In some examples, the straps 220 are sized such that when the blanket 205 is in compact form and inserted into the storage pouch 210, the straps 220 protrude from an opening in the storage pouch 210. In some examples, the blanket 205 is sized such that when not in compact form (e.g., unfolded), the blanket 205 can substantially cover a fire that may occur, for example, on a kitchen stove, an outdoor barbecue, etc.

Some examples of the storage pouch 210 are configured to be mounted to a surface, such as a wall in a kitchen. For example, one side of the storage pouch 210 may comprise one or more adhesive fasteners, hook-and-loop fasteners, etc., to facilitate releasable securing the storage pouch 210 to the surface.

Referring to FIG. 2B, the fire suppression member 205 and the support member 210 of the fire suppression system 105 correspond respectively to a canister 205 of flame-retardant material and a bracket 210. Some examples of the canister 205 correspond to a metal or fiberglass cylinder. Some examples of the flame-retardant material correspond to extinguishing agents such as dry chemicals, carbon dioxide (CO₂), or foam, each tailored to specific types of fires, whether involving flammable liquids, electrical equipment, or ordinary combustibles. Upon activation, these chemicals are rapidly expelled through a nozzle, allowing the user to direct the extinguishing agent precisely where it is needed.

Some examples of the bracket 210 are configured to be mounted to a surface, such as a wall in a kitchen. For example, one side of the bracket 210 may comprise one or more adhesive fasteners, hook-and-loop fasteners, etc., to facilitate releasable securing the bracket 210 to the surface.

a. Fire Suppression System Communication Circuitry

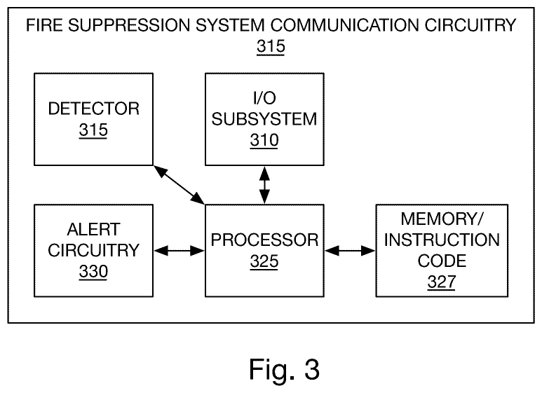

FIG. 3 illustrates an example of the fire suppression system communication circuitry 215 of the fire suppression systems 105 of FIGS. 2A and 2B. Referring to the figure, the fire suppression system communication circuitry 215 includes a memory 327, a processor 325, alert circuitry 330, an input/output (I/O) subsystem 310, and a fire suppression member removal detector 315.

The processor 325 is in communication with the memory 327 and is configured to execute instruction code stored in the memory 327. The instruction code facilitates performing, by the fire suppression assembly 105, various operations that are described herein. In this regard, some examples of the instruction code cause the processor 325 to control and coordinate various activities performed by the different subsystems of the fire suppression assembly 105. Some examples of the processor 325 correspond to a stand-alone computer system such as an ARM®, Intel®, AMD®, or PowerPC® based computer system or a different computer system and can include application-specific computer systems. Some examples of the computer system include an operating system. Examples of the operating system include Android™, Windows®, Linux®, Unix®, or a different operating system.

Some examples of the I/O subsystem 310 include one or more input/output interfaces configured to facilitate communications with entities outside of the fire suppression assembly 105. Some examples of the I/O subsystem 310 include wireless communication circuitry configured to facilitate communicating information to and from the remote device 110. Examples of the wireless communication circuitry include cellular telephone communication circuitry configured to communicate information over a POTS network or a cellular telephone network such as a 3G, 4G, and/or 5G network. Other examples of the wireless communication circuitry facilitate the communication of information via a WiFi-based network, Bluetooth®, Zigbee®, near-field communication technology or a different wireless network.

Some examples of the I/O subsystem 310 include Ultra-Wideband (UWB) circuitry that communicates with UWB circuitry of the remote device 110. The UWB signals communicated between the fire suppression system 105 and the remote device 110 allow the remote device 110 to precisely locate the fire suppression system 105 by measuring the time-of-flight of the signals.

Some examples of the I/O subsystem 310 are configured to communicate information via a RESTful API or a Web Service API. Some examples of I/O subsystem 310 implement a web server to facilitate generating one or more web-based interfaces through which users of the fire suppression system 105 and/or other systems interact with the fire suppression system 105.

Some examples of the fire suppression member removal detector 315 comprise a switch that detects when the fire suppression member 205 is removed from the storage member 210. Within examples, the switch may correspond to a mechanical switch, optical switch, magnetic/hall effect switch, etc. In some examples, when the fire suppression member 205 is removed from the support member 210, the switch may transition from a closed state to an open state or vice versa.

Some examples of the fire suppression member removal detector 315 comprise alert circuitry 330 such as audio and/or visual alert circuitry. Within examples, the audio alert circuitry may comprise a speaker, piezoelectric buzzer, etc., configured to generate an audio alert sound. The visual alert circuitry may comprise one or more incandescent or LED light bulbs, strobe lights, etc., configured to generate a visual alert. In some examples, the audio alert and/or visual alert are generated in response to receipt, by the fire suppression system 105, of a fire suppression system location request indication 122 from the remote device 110.

In some example fire suppression system setup operations, a peer-to-peer network may be established between the fire suppression system 105 and the remote device 110. During setup operations, the fire suppression system communication circuitry 215 may communicate fire suppression system identifying information such as the manufacture and the model of the fire suppression system 105, a unique ID or serial number of the fire suppression system 105, etc. In some examples, the fire suppression system communication circuitry 215 stores inspection date information that indicates one or more dates by which the fire suppression system 105 should be inspected and the inspection date information is communicated to the remote device 110.

In some example fire suppression system setup operations, the remote device 110 communicates location information to the fire suppression system communication circuitry 215 and the fire suppression system communication circuitry 215 stores the location information. Some examples of the location information indicate a physical location of the fire suppression system 105 within a dwelling. For example, the location information may indicate that the fire suppression system 105 is in a kitchen, laundry room, pantry, etc., of a dwelling.

In some example usage operations, upon detecting the removal of the fire suppression member 205 from the support member 210, the fire suppression system communication circuitry 215 communicates a fire suppression member removal indication 120 to the remote device 110. In some examples, the fire suppression member removal indication 120 may uniquely identify the fire suppression system 105 from among a plurality of fire suppression systems. For example, the fire suppression member removal indication may specify a serial number of the fire suppression system 105. In some examples, the fire suppression member removal indication may specify other information such as the manufacture of the fire suppression system 105, the model of the fire suppression system 105, etc.

In some examples, after communicating the fire suppression member removal indication 120 to the remote device 110, the fire suppression system 105 receives, from the remote device 110, an indication that either a first responder system 115 has been contacted or that the fire suppression member removal indication 120 will be ignored. In these examples, when neither of these indications is received by the fire suppression system 105 for a predetermined period (e.g., 5 minutes), the fire suppression system 105 automatically communicates a first responder request indication 130 to the first responder system.

b. Remote Device

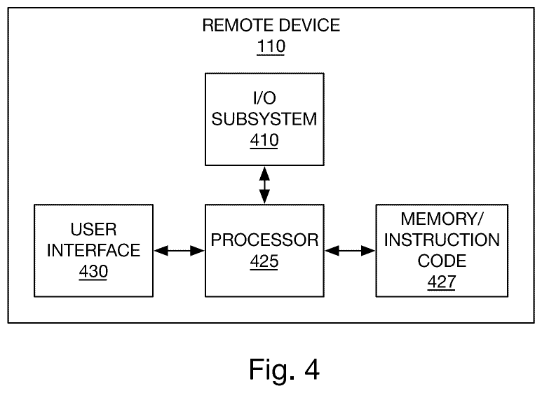

FIG. 4 illustrates an example of a remote device 110. Referring to the figure, the remote device 110 includes a memory 427, a processor 425, a user interface 430, and an input/output (I/O) subsystem 410.

The processor 425 is in communication with the memory 427 and is configured to execute instruction code stored in the memory 427. The instruction code facilitates performing, by the remote device 110, various operations that are described herein. In this regard, some examples of the instruction code cause the processor 425 to control and coordinate various activities performed by the different subsystems of the remote device 110. Some examples of the processor 425 correspond to a stand-alone computer system such as an ARM®, Intel®, AMD®, or PowerPC® based computer system or a different computer system and can include application-specific computer systems. Some examples of the computer system include an operating system. Examples of the operating system include Android™, Windows®, Linux®, Unix®, or a different operating system.

Some examples of the I/O subsystem 410 include one or more input/output interfaces configured to facilitate communications with entities outside of the remote device 110. Some examples of the I/O subsystem 410 include wireless communication circuitry configured to facilitate communicating information to and from the remote device 110. Examples of the wireless communication circuitry include cellular telephone communication circuitry configured to communicate information over a cellular telephone network such as a 3G, 4G, and/or 5G network. Other examples of the wireless communication circuitry facilitate the communication of information via a WiFi-based network, Bluetooth®, Zigbee®, near-field communication technology or a different wireless network.

Some examples of the I/O subsystem 410 include Ultra-Wideband (UWB) circuitry that communicates with UWB circuitry of the fire suppression system 105. The UWB signals communicated between the fire suppression system 105 and the remote device 110 allow the remote device 110 to precisely locate the fire suppression system 105 by measuring the time-of-flight of the signals.

Some examples of the I/O subsystem 410 are configured to communicate information via a RESTful API or a Web Service API. Some examples of I/O subsystem 410 implement a web server to facilitate generating one or more web-based interfaces through which users of the remote device 110 and/or other systems interact with the remote device 110.

### III. Example Operations

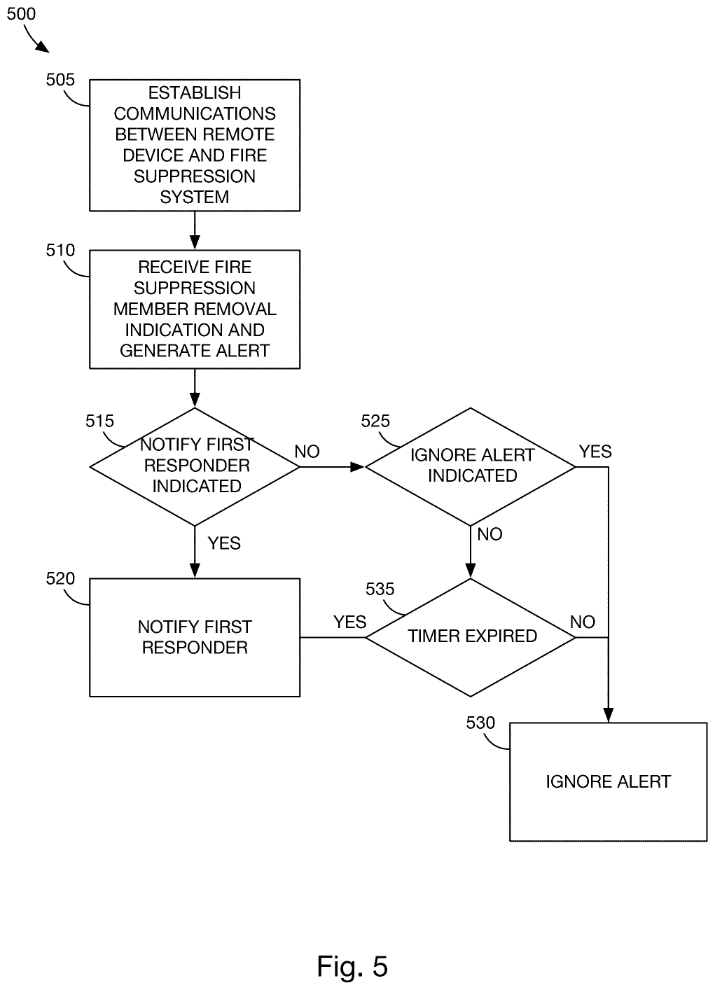

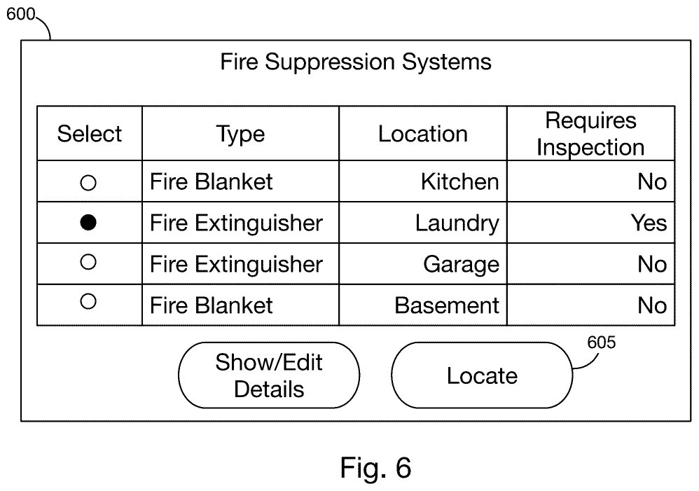

FIG. 5 illustrates examples of operations 500 performed by the remote device and/or the fire suppression system 105. In some examples, one or more of these operations are implemented via instruction code, stored in corresponding data storage (e.g., memory 327) of the remote device 110 and/or the fire suppression system 105. Execution of the instruction code by corresponding processors of the systems causes these systems to perform these operations alone or in combination with other systems and/or devices. The operations 500 in FIG. 5 are understood more clearly with reference to FIGS. 6-8.

The operations at block 505 involve establishing communications between the remote device 110 and the fire suppression system 105. For instance, in some examples, the communication interface of the remote device 110 and the fire suppression system 105 facilitate peer-to-peer communications such as Bluetooth communications. In this case, establishing communications may involve causing the fire suppression system 105 to enter a pairing mode of operation and causing the remote device 110 to scan for Bluetooth devices in this mode.

In some examples, after establishing communications, the fire suppression system 105 may communicate fire suppression system information to the remote device 110.

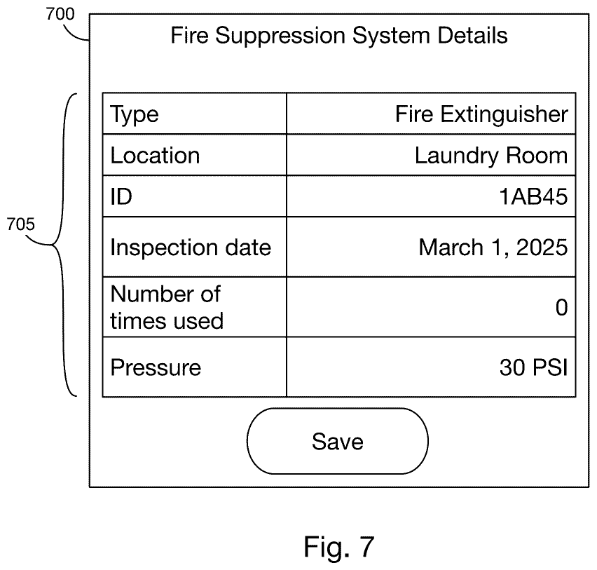

FIGS. 6 and 7 depict examples of user interfaces 600, 700 that may be generated by the remote device 110 to display some of the fire suppression system information 705. For instance, as shown in FIG. 7, in some examples, the communicated fire suppression system information 705 includes an identifier that uniquely identifies the fire suppression system 105 among a plurality of fire suppression systems 105. The unique identifier may correspond to a serial number of the fire suppression system 105, a MAC address associated with the communication interface of the fire suppression system 105, a hash of other information associated with the fire suppression system 105, etc.

In some examples, the fire suppression system information 705 indicates the type of the fire suppression system 105. For example, the fire suppression system information 705 may indicate that the fire suppression system is a fire blanket-based fire suppression system, a fire extinguisher-based fire suppression system, etc. Some examples of the fire suppression system information 705 may indicate physical attributes associated with the fire suppression system 105 such as the size of a fire blanket, the size of a chemical canister, the type of chemical stored in the canister, etc.

In some examples, the fire suppression system information 705 indicates the location of the fire suppression system 105. For example, in the context of a dwelling, the fire suppression system information 705 may indicate that the fire suppression system 105 is located in a kitchen, laundry room, garage, basement, etc. In some examples, the fire suppression system information 705 indicates inspection date information that indicates one or more dates by which the fire suppression system 105 should be inspected. In this regard, in some examples, if the inspection date for a particular fire suppression system 105 is in the past or is within a predetermined period of the current date (e.g., within 1 month), the remote device 110 may update the user interface to indicate that the particular fire suppression system 105 requires inspection.

As indicated by FIG. 6, in some examples, the remote device 110 may be paired with several fire suppression systems 105. In some examples, a user of the remote device 110 may select and edit information associated with a particular fire suppression system 105. For example, the user may be presented with the user interface of FIG. 7 and may be allowed to edit certain parameters, such as the location field to assign a location to a particular fire suppression system 105. After specifying the location information, the location information may be communicated to and stored within the fire suppression system communication circuitry 315 of the particular fire suppression system 105. Similarly, the user may be allowed to update the inspection date information associated with the particular fire suppression system 105 after performing an inspection of the particular fire suppression system 105. In some examples, the remote device 110 communicates the updated inspection date information to the fire suppression system communication circuitry 215 of the fire suppression system 105, which may then store the updated inspection date information.

Returning to FIG. 6, in some examples, after a particular fire suppression system 105 has been paired with the remote device 110, the user of the remote device 110 may select the particular fire suppression system 105 and then select a locate control 605 to locate the selected fire suppression system 105. In some examples, selecting of the locate control 605 causes the remote device 110 to communicate a fire suppression system location request indication 122 to the selected fire suppression system 105. Receipt of the fire suppression system location request indication 122 by the selected fire suppression system 105 causes the selected fire suppression system 105 to generate an audio alert and/or visual alert. This, in turn, may allow a user to locate the selected fire suppression system 105. In some examples, the remote device 110 and the fire suppression system 105 may comprise UWB communication circuitry, and the remote device 110 may use signals communicated via the UWB communication circuitry to guide the user to the fire suppression system 105.

The operations at block 510 involve the remote device 110 receiving a fire suppression member removal indication 120 from a fire suppression system 105. The fire suppression member removal indication 120 indicates to the remote device 110 that the fire suppression member 205 has been removed from the support member 210, presumably to extinguish a fire. Some examples of the fire suppression member removal indication 120 indicate, for example, a serial number or ID of the of the fire suppression system 105, the manufacture and the model of the fire suppression system 105, the location of the fire suppression system 105, etc. Some examples of the fire suppression member removal indication 120 indicate other information associated with the fire suppression system 105, such as inspection date information, usage information, pressure information (e.g., in the case of a fire extinguisher), etc. In regard to the usage information, the usage information may indicate the number of times that the corresponding fire suppression system 105 has been used. In some examples, after receiving the fire suppression member removal indication 120, the remote device 110 may increase the usage count. In some examples, the remote device 110 communicates the updated usage count to the fire suppression system communication circuitry 215 of the fire suppression system 105, which may then store the updated usage count.

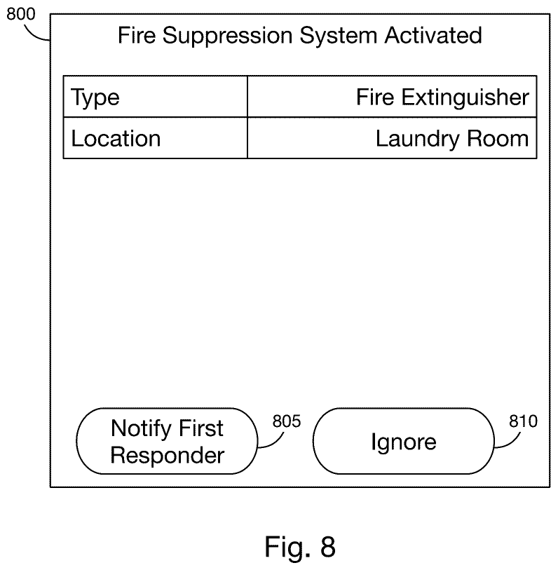

As shown in FIG. 8, in some examples, after receiving the fire suppression member removal indication 120 from a fire suppression system 105, the remote device 110 may generate a user interface 800 to alert the user regarding the removal of the fire suppression member 205 from the support member 210. Some examples of the user interface 800 may include a first responder notification control 805, which when selected by the user, causes the remote device 110 to communicate a first responder request indication 130 to a first responder system 115 or to a home security monitoring system. In some examples, the first responder request indication 130 indicates the address (e.g., street address) associated with the fire suppression system 105. In some examples, the first responder request indication 130 indicates the location of the fire suppression system 105. Other information, such as a serial number or ID of the fire suppression system 105, the manufacturer and the model of the fire suppression system 105, etc., may be specified in the first responder request indication 130.

If at block 515, the first responder notification control 805 is selected, the operations at block 520 are performed. The operations at block 520 involve communicating the first responder request indication 130 to the first responder system 115.

If at block 515, the first responder notification control 805 is not selected and if at block 525, the user indicates that the fire suppression member removal indication 120 should be ignored, then the indication is ignored as indicated by the operations in block 530. For example, some examples of the user interface 800 may include an ignore first responder notification control 810 that, when selected by the user, causes the remote device 110 to ignore the fire suppression member removal indication 120.

If at block 525, the user does not indicate that the fire suppression member removal indication 120 should be ignored and if at block 535 a predetermined amount of time has passed, then the operations at block 520 that involve communicating the first responder request indication 130 to the first responder system 115 are performed. For instance, if the user does not indicate within, for example, five minutes that the fire suppression member removal indication 120 should be ignored, the first responder request indication 130 is automatically communicated to the first responder system 115.

### IV. Example Computer Systems

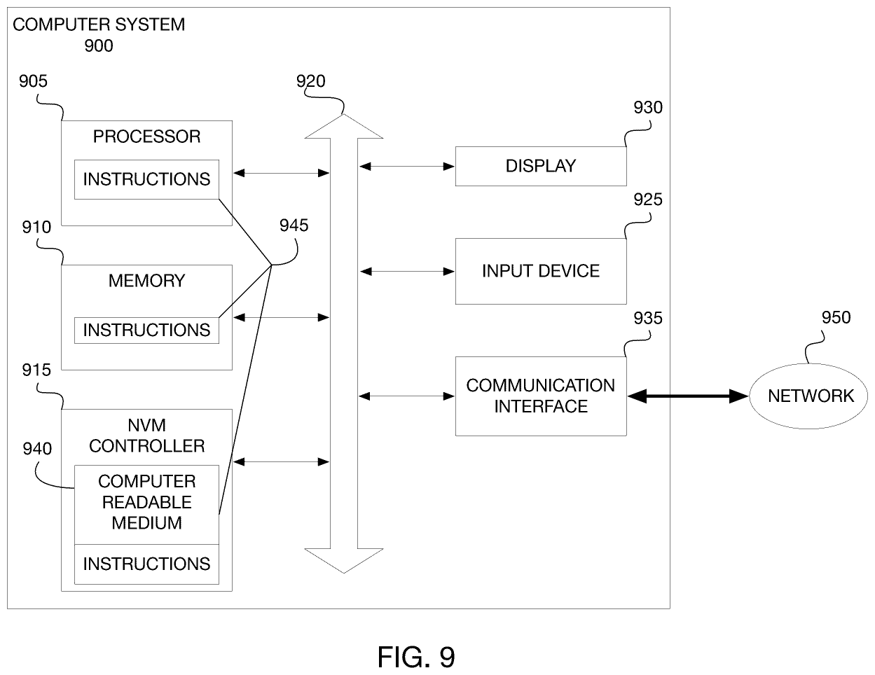

FIG. 9 illustrates an example of a computer system 900 that can form part of or implement any of the systems and/or devices described above. The computer system 900 can include a set of instructions 945 that the processor 905 can execute to cause the computer system 900 to perform any of the operations described above. An example of the computer system 900 can operate as a stand-alone device or can be connected, e.g., using a network, to other computer systems or peripheral devices.

In a networked example, the computer system 900 can operate in the charge capacity of a server or as a client computer in a server-client network environment, or as a peer computer system in a peer-to-peer (or distributed) environment. The computer system 900 can also be implemented or incorporated into various devices, such as a personal computer or a mobile device, capable of executing instructions 945 (sequential or otherwise), causing a device to perform one or more actions. Further, each of the systems described can include a collection of subsystems that individually or jointly execute a set, or multiple sets, of instructions to perform one or more computer operations.

The computer system 900 can include one or more memory devices 910 communicatively coupled to a bus 920 for communicating information. In addition, code operable to cause the computer system to perform operations described above can be stored in the memory 910. The memory 910 can be random-access memory, read-only memory, programmable memory, or any other type of memory or storage device.

The computer system 900 can include a display 930, such as a liquid crystal display (LCD), organic light-emitting diode (OLED) display, or any other display suitable for conveying information. The display 930 can act as an interface for the user to see processing results produced by processor 905.

Additionally, the computer system 900 can include an input device 925, such as a keyboard or mouse or touchscreen, configured to allow a user to interact with components of system 900.

The computer system 900 can also include a non-volatile memory (NVM) controller 915. The NVM controller 915 can include a computer-readable medium 940 (e.g., flash drive) in which the instructions 945 can be stored. The instructions 945 can reside completely, or at least partially, within the memory 910 and/or within the processor 905 during execution by the computer system 900. The memory 910 and the processor 905 also can include computer-readable media, as discussed above.

The computer system 900 can include a communication interface 935 to support communications via a network 950. The network 950 can include wired networks, wireless networks, or combinations thereof. The communication interface 935 can enable communications via any number of wireless broadband communication standards.

Accordingly, methods and systems described herein can be realized in hardware, software, or a combination of hardware and software. The methods and systems can be realized in a centralized fashion in at least one computer system or in a distributed fashion where different elements are spread across interconnected computer systems. Any kind of computer system or other apparatus adapted for carrying out the methods described herein can be employed.

The methods and systems described herein can also be embedded in a computer program product, which includes all the features enabling the implementation of the operations described herein and which, when loaded in a computer system, can carry out these operations. Computer program as used herein refers to an expression, in a machine-executable language, code or notation, of a set of machine-executable instructions intended to cause a device to perform a particular function, either directly or after one or more of a) conversion of a first language, code, or notation to another language, code, or notation; and b) reproduction of a first language, code, or notation.

While the systems and methods of operation have been described with reference to certain examples, it will be understood by those skilled in the art that various changes can be made and equivalents can be substituted without departing from the scope of the claims. Therefore, it is intended that the present methods and systems not be limited to the particular examples disclosed, but that the disclosed methods and systems include all embodiments falling within the scope of the appended claims.

What is claimed is:

1. A fire suppression system comprising:
a fire suppression member configured to extinguish a fire;
a support member configured to removably couple the fire suppression member to a surface; and
a circuit configured to, after determining that the fire suppression member has been removed from the support member, communicate a fire suppression member removal indication to a remote device.

2. The fire suppression system according to claim 1, wherein:
the fire suppression member comprises a blanket of flame-resistant material, wherein the blanket comprises one or more handles; and
the support member comprises a storage pouch configured to store the blanket in a compact form such that when the blanket is in the compact form and inserted within the storage pouch, the one or more handles protrude from an opening of the storage pouch.

3. The fire suppression system according to claim 1, wherein the fire suppression member comprises:
a canister having stored therein, and under pressure, a consumable frame retardant material; and
a pressure gauge to sense the pressure of the consumable frame retardant material, wherein the circuit is further configured to communicate an indication of a sensed pressure to the remote device.

4. The fire suppression system according to claim 2, wherein the circuit is further configured to:
store an inspection date indication that specifies a date by which the fire suppression member should be inspected; and
communicate the inspection date indication to the remote device.

5. The fire suppression system according to claim 1, wherein the circuit is configured to wirelessly communicate the fire suppression member removal indication to the remote device.

6. The fire suppression system according to claim 1, wherein the fire suppression system is one of a plurality of fire suppression assemblies, wherein the fire suppression member removal indication uniquely identifies the fire suppression assembly among the plurality of fire suppression assemblies.

7. The fire suppression system according to claim 1, wherein the circuit comprises:
one or more audio or visual alert circuits configured to generate, respectively, audio or visual indications, wherein the circuit is further configured to, after receiving a fire suppression system location request indication from the remote device, output one or more of the audio or visual indications.

8. The fire suppression system according to claim 1, wherein the remote device is configured to, after receiving the fire suppression member removal indication, communicate a first responder request indication to a first responder network.

9. The fire suppression system according to claim 8, wherein the first responder request indication specifies a particular location of the fire suppression system.

10. The fire suppression system according to claim 8, wherein the first responder request indication specifies a particular room of a dwelling.

11. The fire suppression system according to claim 6, wherein the remote device corresponds to a mobile device.

12. A computing device comprising:
one or more processors; and
one or more storage devices that comprise instruction code that is executable by the one or more processors to cause the computing device to perform operations comprising:
after a fire suppression member of a fire suppression assembly has been removed from a support member of the fire suppression assembly, receiving, from the fire suppression assembly, a fire suppression member removal indication; and
updating a user interface of the computing device to indicate that the fire suppression member has been removed from the support member.

13. The computing device according to claim 12, wherein the instruction code for updating the user interface comprises instruction code that causes the computing device to perform further operations comprising:
after receiving the fire suppression member removal indication, updating the user interface to request, from a user of the computing device, whether a first responder should be notified; and
after receiving an indication that the first responder should be notified, communicate a first responder request indication to a first responder.

14. The computing device according to claim 13, wherein the instruction code for updating the user interface comprises instruction code that causes the computing device to perform further operations comprising:
before receiving the indication that the first responder should be notified and after a predetermined period from receipt of the fire suppression member removal indication, automatically communicate the first responder request indication to a first responder.

15. The computing device according to claim 12, wherein the fire suppression member removal indication uniquely identifies the fire suppression assembly among a plurality of fire suppression assemblies, wherein the instruction code for updating the user interface comprises instruction code that causes the computing device to perform further operations comprising:
updating the user interface to indicate information that identifies the fire suppression member associated with the fire suppression member removal indication.

16. The computing device according to claim 12, further comprising instruction code that causes the computing device to perform further operations comprising:
updating the user interface to indicate identifying information associated with each of a plurality fire suppression assemblies; and
after receiving a selection of a particular identified fire suppression assembly, communicate a fire suppression member location request indication to the particular identified fire suppression assembly, wherein the particular identified fire suppression assembly is configured to generate one or more of an audio or visual indication that facilitates locating the particular identified fire suppression assembly.

17. The computing device according to claim 12, further comprising instruction code that causes the computing device to perform further operations comprising:
receiving, from one or more fire suppression assemblies, respective indications of inspection dates associated with the one or more fire suppression assemblies; and
after a current date is within a predetermined period of the inspection date associated with a particular fire suppression assembly, updating the user interface to indicate that the particular fire suppression assembly requires inspection.

18. The computing device according to claim 13, wherein the first responder request indication specifies a particular location of the fire suppression assembly.

19. The computing device according to claim 12, wherein the computing device corresponds to a mobile device.

20. A non-transitory computer-readable medium having stored thereon instruction code that, when executed by one or more processors of a computing device, causes the computing device to perform operations comprising:
after a fire suppression member of a fire suppression assembly has been removed from a support member of the fire suppression assembly, receiving, from the fire suppression assembly, a fire suppression member removal indication; and
updating a user interface of the computing device to indicate that the fire suppression member has been removed from the support member.
